(19) United States
(12) Patent Application Publication
(10) Pub. No.: US 2025/0154003 A1
(43) Pub. Date: May 15, 2025

(54) STEAM-METHANE REFORMING IN HYDROGEN PRODUCTION

(71) Applicant: SAUDI ARABIAN OIL COMPANY, Dhahran (SA)

(72) Inventors: Eiman Hassan AL MUNIF, Dhahran (SA); Norah A. ALJEABAN, Dhahran (SA)

(73) Assignee: SAUDI ARABIAN OIL COMPANY, Dhahran (SA)

(21) Appl. No.: 18/509,111

(22) Filed: Nov. 14, 2023

(51) Int. Cl. C01B 3/40; B01D 53/047; B01J 27/043; C01B 3/48; C01B 3/56

(52) U.S. Cl. CPC C01B 3/40; B01D 53/047; B01J 27/043; C01B 3/48; C01B 3/56; B01D 2256/16; B01D 2257/504; C01B 2203/0233; C01B 2203/0283; C01B 2203/0425; C01B 2203/0475; C01B 2203/1047; C01B 2203/1241

(57) ABSTRACT

System and methods for producing hydrogen, the system comprising: a reformer unit configured to generate a reformate gas via a steam-methane reaction that is aided by an iron sulfide catalyst; and, a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas. Further systems use a water treatment system coupled to a steam generator, a reformer unit configured to generate a reformate gas via a steam-methane reaction, and a shift reactor.

### FIELD OF THE DISCLOSURE

The present disclosure relates generally to steam-methane reforming applications in hydrogen production and, more particularly, to hydrogen production via a catalyst aided steam-methane reforming reaction and water-gas shift reaction.

### BACKGROUND OF THE DISCLOSURE

Hydrogen has a variety of industrial applications, including: ammonia production, methanol synthesis, petroleum refining, and as a fuel in fuel cells. However, conventional methods of producing hydrogen (e.g., such as natural gas steam reforming, partial oxidation, and electrolysis) have various drawbacks. For example, natural gas steam reforming and partial oxidation can emit significant amounts of carbon dioxide (CO₂) contributing to Greenhouse gas emissions. Electrolysis can be a cleaner method for producing hydrogen, but requires a large amount of electrical energy.

Steam-methane reforming is an alternative method for producing hydrogen. In the steam-methane reforming process, methane (CH₄) reacts with water (H₂O) to product hydrogen gas (H₂) and carbon monoxide (CO). Subsequently, the carbon dioxide can be reacted with water to produce carbon dioxide (CO₂) and additional hydrogen gas.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to some embodiments consistent with the present disclosure, systems for producing hydrogen are provided. The system may comprise a reformer unit configured to generate a reformate gas via a steam-methane reaction that is aided by an iron sulfide catalyst; and, a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas.

In other embodiments, a methods for producing hydrogen are provided. The method can comprise generating, via a reformer unit, a reformate gas by a steam-methane reaction aided by an iron sulfide catalyst; generating additional hydrogen, via a shift reactor, by a water-shift reaction applied to the reformate gas; and, utilizing a presence of the iron sulfide catalyst within the reformate gas to lower the activation energy of the water-gas shift reaction.

In a further embodiment, other systems are provided. The systems can comprise a water treatment system coupled to a steam generator, wherein the water treatment system is configured to remove contaminants from a water supply derived from a hydrocarbon well and provide treated water to the steam generator, and wherein the steam generator heats the treated water to provide steam to the reformer unit; a reformer unit configured to generate a reformate gas via a steam-methane reaction that is aided by an iron sulfide catalyst; and, a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a non-limiting example hydrogen production system 100 that can produce hydrogen from a steam-methane reaction aided by iron sulfide catalyst in accordance with one or more embodiments described herein.

FIG. 2 is a flow diagram of a non-limiting example method for producing hydrogen that can employ a steam-methane reaction aided by iron sulfide catalyst in accordance with one or more embodiments described herein.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to producing hydrogen gas via a catalyst (e.g., iron sulfide) aided steam-methane reaction and water-gas shift reaction. In various embodiments, the systems and/or methods described herein can utilize a water and/or methane supply from one or more established hydrocarbon wells to feed the steam-methane reaction. For instance, the water can be sourced from one or more mature hydrocarbon wells that produce high water cut supplies. Further, the steam-methane reaction can be aided by one or more catalysts, such as iron sulfide, that can further lower the activation energy of the water-gas shift reaction. Advantageously, the catalyst that aids the steam-methane reforming reaction can be recycled to further catalyze the water-gas shift reaction. Thereby, the systems and/or methods described herein can be more energy efficient than conventional methods, with efficiency ranging from about 70% to about 85%.

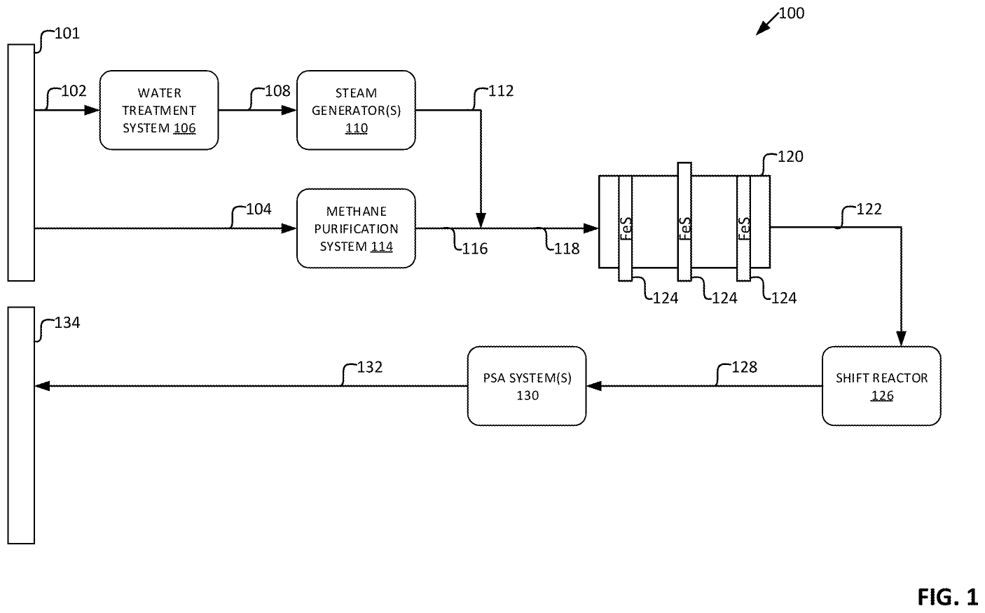

FIG. 1 depicts a hydrogen production system 100 for producing hydrogen from one or more hydrocarbon wells 101 via one or more catalyst aided steam-methane reactions in accordance with one or more embodiments described herein. As shown in FIG. 1, the hydrogen production system 100 can include one or more piping circuits to carry and/or route fluids between various features of the hydrogen production system 100. For example, FIG. 1 depicts the one or more piping circuits via solid arrows, where the direction of the arrows can indicate the direction of flow within the piping circuit. In various embodiments, the one or more fluid streams (e.g., gas streams) can be housed, carried, and/or routed within the piping circuitry. For instance, respective sections of the piping circuit can route respective fluid streams between components of the hydrogen production system 100 in accordance with various embodiments described herein.

In various embodiments, the hydrogen production system 100 can utilize an initial water stream 102 and a natural gas stream 104 to supply one or more steam-methane reactions described herein. For example, the initial water stream 102 can be sourced from one or more hydrocarbon wells 101. For instance, the initial water stream 102 can be a high water cut output from the hydrocarbon wells 101. As shown in FIG. 1, the initial water stream 102 can be supplied to a water treatment system 106. In various embodiments, the water treatment system 106 can pre-treat the initial water stream 102 to remove undesired impurities that may mitigate catalyst activity during the steam-methane reaction. For example, impurities in the initial water stream 102 may, unless treated by the water treatment system 106, deposit onto one or more catalysts described herein; thereby blocking the activation sites of the catalyst.

For example, where the initial water stream 102 is a high water cut output from one or more hydrocarbon wells 101, the initial water stream 102 can be a byproduct of oil and gas extraction and can typically contain various contaminants, including, but not limited to: oil, grease, sales, metals, organic compounds, a combination thereof, and/or the like. The water treatment system 106 can be employed to remove the contaminants of the initial water stream 102 via one or more water treatment techniques, such as, but not limited to: oil-water separation, filtration (e.g., media filters, cartridge filters, and/or bag filters), coagulation and/or flocculation, desalination, biological treatment, advanced oxidation, adsorption, ion exchange, thermal treatments, membrane filtration, chemical precipitation, a combination thereof, and/or the like. The choice of treatment techniques utilized by the water treatments system 106 can vary depending on the specific contaminants present in the initial water stream 102 and/or the desired water quality. In various embodiments, the water treatment system 106 can be a part of the hydrogen production system 100 (e.g., as shown in FIG. 1). Alternatively, the water treatment system 106 can be part of a separate processing facility, where the output of the water treatment system 106 is supplied to the hydrogen production system 100.

As shown in FIG. 1, a treated water stream 108 can be supplied from the water treatment system 106 to one or more steam generators 110. In various embodiments, the steam generators 110 can heat the treated water stream 108 to produce a vapor stream 112 of superheated steam. Example types of steam generators 110 that may be employed include, but are not limited to: fire-tube boilers, water-tube boilers, electric steam boilers, once-through steam generators, heat recovery steam generators, waste heat boilers, package boilers, fluidized bed boilers, biomass boilers, thermal oil heaters, a combination thereof, and/or the like. In various embodiments, the vapor stream 112 can have a temperature ranging from greater than or equal to about 120° C. to less than or equal to about 600° C. In various embodiments, the vapor stream 112 can have a pressure ranging from greater than or equal to about 14 bar to less than or equal to about 40 bar.

Further, the natural gas stream 104 can be supplied to one or more methane purification systems 114. For example, where the natural gas stream 104 is sourced from a hydrocarbon well 101, the natural gas can contain various hydrocarbons other than methane, such as: ethane, propane, butane, and/or various impurities (e.g., water vapor, carbon dioxide, hydrogen sulfide, nitrogen, and/or the like). The one or more methane purification systems 114 can be employed to process the natural gas stream 104 and generate a purified methane stream 116. Example processing techniques that can be employed by the methane purification systems 114 can include, but are not limited to: gas dehydration, acid gas removal, natural gas liquids recovery, nitrogen removal, mercury removal, desulphurization, a combination thereof, and/or the like. For instance, the methane purification systems 114 can include a desulphurization unit. In various embodiments, the natural gas stream 104 can be processed by the one or more methane purification systems 114 such that the purified methane stream 116 is characterized by a methane purity level of preferably 97.5% CH₄ mol. Additionally, in one or more embodiments, the purified methane stream 116 can be supplied to one or more compressors or expanders to provide the purified methane stream 116 at a desired pressure for the steam-reforming reaction.

While FIG. 1 depicts the initial water stream 102 and the natural gas stream 104 being supplied directly from the hydrocarbon wells 101, the architecture of the hydrogen production system 100 is not so limited. For example, embodiments in which the output of the hydrocarbon wells 101 is first supplied to one or more processing facilities are also envisaged. For example, the processing facilities (not shown) may extract one or more other desirable products from the hydrocarbon well 101 output prior to introduction to the hydrogen production system 100. Additionally, one or more of the components of the hydrogen production system 100 can be included in the processing facilities (e.g., such as the water treatment system 106 and/or the methane purification system 114).

As shown in FIG. 1, the vapor stream 112 (e.g., superheated steam) can be mixed with the purified methane stream 116 to form inlet gas stream 118 prior to introduction to one or more reformer units 120. In one or more embodiments, the inlet gas stream 118 can have a high steam-to-carbon ratio (e.g., between about 2.5:1 and about 3:1). For example, the excess of water provided by the high steam-to-carbon ratio can mitigate catalyst deactivation. Further, contact with the superheated vapor stream 112 can serve to pre-heat the purified methane stream 116. In various embodiments, the inlet gas stream 118 can have a temperature ranging from greater than or equal to about 20° C. to less than or equal to about 150° C. In various embodiments, the inlet gas stream 118 can have a pressure ranging from greater than or equal to about 20 bar to less than or equal to about 40 bar. In some embodiments, the vapor stream 112 and the purified methane stream 116 can be provided to the one or more reformer units 120 separately, where the purified methane stream 116 may be pre-heated (e.g., via a heat exchanger and combustion gas exhaust from the one or more reformers 120) and/or pressurized (e.g., via one or more compressors) prior to entering the one or more reformer units 120.

The one or more reformer units 120 can facilitate a steam-methane reforming reaction to produce a reformate stream 122; which can include a syngas, excess water, and/or excess catalyst. While FIG. 1 depicts the use of a single reformer unit 120, the architecture of the hydrogen production system 100 is not so limited. For example, embodiments that include a plurality of reformer units 120 (e.g., connected in parallel or in series) are also envisaged. The reformer unit 120 can include one or more burners (not shown) powered by one or more fuel streams (e.g., which can be a portion of the natural gas stream 104 diverted directly to the one or more reformer units 120) (not shown) and/or air streams (not shown). The one or more burners can heat the inlet gas stream 118 as the inlet gas stream 118 is passed through one or more catalyst filled tubes 124. Further, the burners can be situated within the reformer unit 120 in various geometries (e.g., the reformer unit 120 can be embodied as a top-fired reformer, a terrace wall filled reformer, a radiant wall reformer, a bottom-fired reformer, or the like). While traversing the catalyst filled tubes 124, the inlet gas stream 116 can undergo a steam-methane reforming reaction characterized by Equation 1 below.

CH₄+H₂O→CO+3H₂ (1)

For instance, the steam-methane reforming reaction is an endothermic reaction that takes place within a heat chamber of the reforming unit 120 between the methane from the purified methane stream 116 and the water from the vapor stream 112 to form the syngas of the reformate stream 122 (e.g., comprising CO+3H₂). In various embodiments, the steam-methane reforming reaction can take place at a high temperature and low pressure within the reforming unit 120. Example operating conditions can include a temperature between about 600° C. and 1000° C.; and a pressure between about 150 psi and about 350 psi.

In one or more embodiments, a combustion gas exhaust produced from heating the reformer unit 120 can be recycled to heat the purified methane stream 116 and/or power the one or more steam generators 110. For instance, a combustion gas exhaust from the reformer unit 120 can be provided to a heat exchanger to pre-heat the purified methane stream 116 prior to mixing with the vapor stream 112. In another instance, the steam generator 110 can be a heat recovery steam generator that can recover heat from the combustion gas exhaust of the reformer unit 120 to produce the vapor stream 112.

In various embodiments, the catalyst filled tubes 124 can be filled with a catalyst, a support compound, and/or a promoter compound to facilitate the steam-methane reforming reaction. Traditionally, the steam-methane reforming reaction can be inhibited by deactivation of the catalyst due to, for example, the deposition of carbon on the catalyst (e.g., resulting from the decomposition of methane, disproportionation of carbon monoxide, and/or reverse water formation). Conventional catalysts utilized in steam-methane reactions are nickel-based catalyst, noble metal-based catalysts, cobalt-based catalysts, and copper-based catalysts. However, each of these conventional catalysts can face substantial challenges. For example, nickel-based catalysts typically result in a high amount of carbon deposition (e.g. coke formation) on the catalysts; and the application of noble metal-based catalysts is substantially limited by the cost thereof. In various embodiments described herein, the hydrogen production system 100 utilizes all stoichiometric variations of iron sulfide catalyst to facilitate both the steam-methane reaction and the subsequent water-gas shift reaction. Advantageously, iron sulfide significant surface area provides a large quantity of active sites that serves to enhance catalytic activity. In addition, iron sulfide chemically facilitates the conversion of carbon monoxide and water into carbon dioxide and hydrogen. Iron sulfide is a cost effective, efficient, scalable, environmentally friendly, and sustainable catalyst.

An example composition of the reformate stream 122 can be: between about 1 vol-% and 6.16 vol-% percent by volume of methane; between about 25 vol-% and 75 vol-% percent by volume of hydrogen; between about 5 vol-% and 20 vol % percent by volume of carbon dioxide; between about 5 vol-% and 20 vol-% percent by volume of carbon monoxide; between about 1 vol-% and 20 vol-% percent by volume of water; and/or between about 0.05 vol-% and 1 vol-% percent by volume of catalyst.

As shown in FIG. 1, the reformate stream 122 can be subsequently supplied to a shift reactor 126 to facilitate an exothermic water-gas shift reaction. While FIG. 1 depicts the use of a single shift reactor 126, the architecture of the hydrogen production system 100 is not so limited. For example, embodiments that include a plurality of shift reactors 126 (e.g., connected in parallel or in series) are also envisaged.

In various embodiments, the water-gas shift reaction can increase the yield of hydrogen produced by the hydrogen production system 100 by converting the carbon monoxide of the reformate stream 122 into carbon dioxide in accordance with Equation 2 below.

CO+H₂O→CO₂+H₂ (2)

In accordance with Equation 2, excess water present in the reformate stream 122 (e.g., an excess resulting from the high steam to carbon ratio of the inlet gas stream 118) can be utilized to convert the carbon monoxide of the reformate stream 122 into carbon dioxide and additional hydrogen.

In various embodiments, residual catalyst from the steam-methane reaction can further catalyze the water-gas shift reaction. For example, the catalyst (e.g., iron sulfide) can lower the activation energy requirement for the water-gas shift reaction by 10% to 30%. For instance, the water-gas shift reaction can be performed at a temperature between, for example, about 200 and about 400° C.; and at a pressure between, for example, about 150 and about 350 psi. In one or more embodiments, the reformate stream 122 can be supplied to a cooler (e.g., an intercooler) (not shown) and/or heat exchanger prior to introduction to the shift reactor 126, where the cooler can cool the reformate stream 122 to a desired temperature for the water-gas shift reaction.

In one or more embodiments, the water-gas shift reaction can be performed via a two stage reaction that includes: a high temperature water-gas shift, and a low temperature water-gas shift. Whether the water-gas shift reaction is a single or two stage reaction can be based on a subsequent hydrogen purification process. For example, where the shift reactor 126 produces an outlet stream 128 that is further processed using a pressure swing adsorption method, the water-gas shift reaction can be performed via a single stage (e.g., as exemplified in FIG. 1). Alternatively, where the outlet stream 128 is further processed using a solvent based removal method, the water-gas shift reaction can be performed via the two stages. In either case, the water-gas shift reaction can be performed at a lower temperature than the steam-methane reforming reaction. For example, the high temperature water-gas shift can be performed at a temperature ranging from between about 350° C. and 500° C. In another example, the low temperature water-gas shift can be performed at a temperature ranging from between about 200° C. and 250° C.

In one or more embodiments, the water-gas shift reaction can reduce the carbon monoxide content to less than about 5 percent by volume. For instance, an example composition of the outlet stream 128 can be: between about 2 vol-% and 7 vol-% percent by volume of methane; between about 40 vol-% and 70 vol-% percent by volume of hydrogen; between about 5 vol-% and 25 vol-% percent by volume of carbon dioxide; between about 3 vol-% and 20 vol-% percent by volume of carbon monoxide.

In one or more embodiments, the catalyst utilized in the steam-methane reaction can further help the water split into hydrogen and oxygen, and can lower the activation energy of the water-gas shift reaction. For example, residual catalyst included in the reformate stream 122 can be recycled to catalyze the water-gas shift reaction.

As shown in FIG. 1, in various embodiments shift reactor 126 can perform a high temperature water-gas shift reaction to generate the outlet stream 128, which can then be supplied to one or more pressure swing adsorption (“PSA”) systems 130. The PSA systems 130 can purify the outlet stream 128 to generate a purified hydrogen stream 132. Alternatively, the water-gas shift can be a two stage process that includes a high temperature water-gas shift reaction and a low temperature water-gas shift reaction; and the outlet stream 128 can be supplied to a solvent-based carbon dioxide removal system that employs one or more purification techniques, such as preferential oxidation, to generate the purified hydrogen stream 130.

Where the PSA system 130 is employed, the PSA system 130 can utilize various sorbents (e.g., zeolite, activated carbon, silica gel, alumina, synthetic resins, and/or the like) to absorb multiple impurities, such as carbon monoxide, carbon dioxide, and/or methane. For instance, the PSA system 130 can utilize molecular sieves to separate carbon-based species from the outlet stream 128. The absorption and/or desorption performed by the PSA system 130 occurs on the change of pressure. The PSA system 130 also produces an off gas/tail gas (not shown). In one or more embodiments, the off gas of the PSA system 130 can be used as a fuel for the one or more reformer units 120. The purified hydrogen stream 132 can comprise at least 99% hydrogen by volume (e.g., 99.99% hydrogen by volume). As shown in FIG. 1, the purified hydrogen stream 132 can be supplied to one or more hydrogen storage units 134 to facilitate subsequent applications.

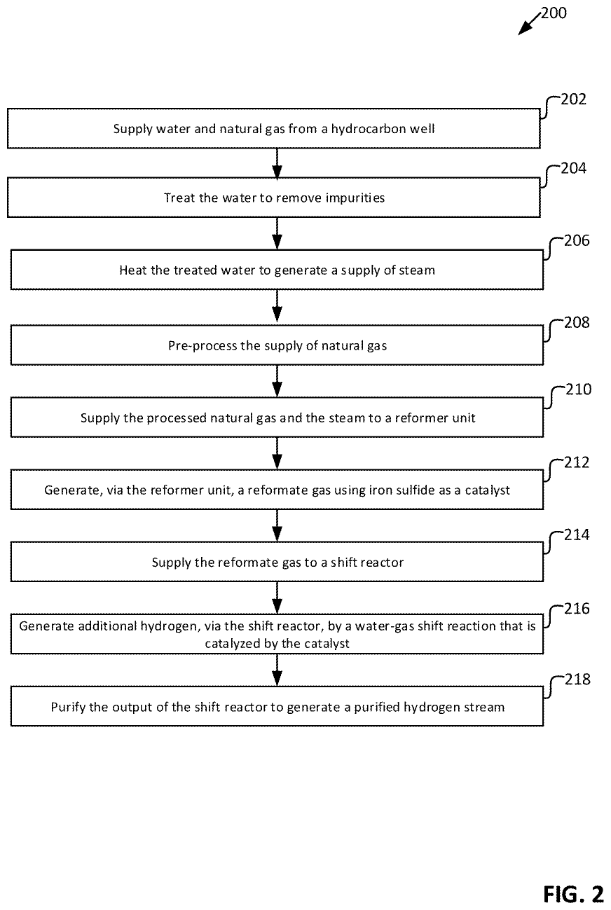

FIG. 2 illustrates a non-limiting example method 200 for producing hydrogen from the output of one or more hydrocarbon wells using a steam-methane reforming reaction catalyzed by iron sulfide in accordance with one or more embodiments described herein. For example, the method 200 can be implemented via hydrogen production system 100. While FIG. 2 illustrates various features in a sequential order, the architecture of the method 200 is not so limited. For example, embodiments in which one or more of the features of method 200 are performed simultaneously, near simultaneously, and/or concurrently are also envisaged.

At 202, the method 200 can comprise supplying water (e.g., initial water stream 102) and natural gas (e.g., natural gas stream 104) from one or more hydrocarbon wells 101. In accordance with one or more embodiments described herein, the water can be a high water cut byproduct of hydrocarbon extraction from the one or more hydrocarbon wells 101.

At 204, the method 200 can comprise treating the water (e.g., initial water stream 102) to remove one or more impurities. In accordance with one or more embodiments described herein, the water (e.g., initial water stream 102) can be treated to remove impurities that may inhibit catalyst activity during a subsequent steam-methane reaction. For example, treating the water at 204 can be performed by one or more water treatment systems 106.

At 206, the method 200 can comprise heating the treated water to generate a supply of steam (e.g., vapor stream 112). In accordance with one or more embodiments described herein, the treated water can be heated to a temperature between about 800° C. and 900° C. For example, the treated water can be heated by one or more steam generators 110.

At 208, the method 200 can comprise pre-processing the supply of natural gas (e.g., pre-processing the natural gas stream 104). In various embodiments, the pre-processing at 208 can be performed simultaneously or concurrently with the treating and heating of the water at 204 and/or 206. In accordance with one or more embodiments described herein, the natural gas supply (e.g., natural gas stream 104) can be processed to generated purified methane. For example, the natural gas supply (e.g., natural gas stream 104) can be processed via one or more methane purification systems 114. Further, the pre-processing at 208 can include adjusting the temperature and/or pressure of the purified methane (e.g., the purified methane stream 116). For instance, the pre-processing at 208 can include pre-heating the methane and/or compressing the methane.

At 210, the method 200 can comprise supplying the processed natural gas and the steam (e.g., as inlet stream 118) to one or more reformer units 120. In accordance with one or more embodiments described herein, the processed natural gas and the steam can be supplied as a combined input to the one or more reformer units 120 (e.g., as shown in FIG. 1), or can be supplied to the reformer unit 120 via distinct inlets and mixed within the reformer unit 120.

At 212, the method 200 can comprise generating, via the one or more reformer units 120, a reformate gas (e.g., reformate gas stream 122) using iron sulfide as a catalyst. In accordance with one or more embodiments described herein, the reformate gas (e.g., reformate gas stream 122) can be the product of a steam-methane reaction (e.g., characterized by Equation 1) performed in the one or more reformer units 120 under high temperature (e.g., between about 600° C. and about 1000° C.) and low pressure (e.g., about 150 to about 350 psi). The reformate gas (e.g., reformate gas stream 122) can comprise at least excess water vapor, syngas, and/or residual catalyst. In one or more embodiments, the method 200 can also include utilizing a combustion gas exhaust of the one or more reformer units 120 to power the one or more steam generators 110 and/or heat the processed methane.

At 214, the method 200 can comprise supplying the reformate gas (e.g., reformate gas stream 122) to one or more shift reactors 126. In accordance with one or more embodiments described herein, the reformate gas (e.g., reformate gas stream 122) can be cooled prior to introduction to the one or more shift reactors 126 (e.g., via one or more cooling units).

At 216, the method 200 can comprise generating additional hydrogen, via the one or more shift reactors 126, by a water-gas shift reaction that is catalyzed by the catalyst composed in the reformate gas (e.g., reformate gas stream 122). For example, the iron sulfide can serve to lower the activation temperature of the water-gas shift reaction and/or facilitate the hydrogen-oxygen split. In accordance with one or more embodiments described herein, the water-gas shift reaction can occur at a temperature between about 200 and about 400° C., and a pressure between about 150 and about 350 psi.

At 218, the method 200 can comprise purifying the output (e.g., output stream 128) of the one or more shift reactors 126 to generate a purified hydrogen stream 132. In accordance with one or more embodiments described herein. The purifying at 218 can be performed via one or more PSA systems 130. For example, the purifying at 218 can remove any carbon-based species and/or contaminants from the produced hydrogen. Additionally, in some embodiments, the off gas of the one or more PSA systems 130 can be used as fuel for the one or more reformer units 120.

### ADDITIONAL EMBODIMENTS

The present disclosure is also directed to the following exemplary embodiments, which can be practiced in any combination thereof:

Embodiment 1: A system for producing hydrogen, the system comprising: a reformer unit configured to generate a reformate gas via a steam-methane reaction that is aided by an iron sulfide catalyst; and a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas.

Embodiment 2: The system according to embodiment 1, further comprising: a steam generator operably coupled to the reformer unit, wherein the steam generator is configured to generate steam for the steam-methane reaction from a water supply sourced from a hydrocarbon well.

Embodiment 3: The system according to any of embodiments 1 or 2, further comprising: a water treatment system operably coupled to the steam generator, wherein the water treatment system is configured to remove contaminants from the water supply prior to supplying the water supply to the steam generator.

Embodiment 4: The system according to any of embodiments 1-3, further comprising: a methane purification system operably coupled to the reformer unit, wherein the methane purification system is configured to generate a methane gas stream for the steam-methane reaction, and wherein the methane gas stream comprises at least 95 molar percent methane.

Embodiment 5: The system according to any of embodiments 1-4, wherein reaction conditions within the shift reactor include a temperature between 200 and 400 degrees Celsius and a pressure between 150 and 350 pounds per square inch.

Embodiment 6: The system according to any of embodiments 1-5, further comprising: a pressure swing adsorption system operably coupled to the shift reactor, wherein the pressure swing adsorption system is configured to generate a purified hydrogen stream from an output of the shift reactor.

Embodiment 7: The system according to any of embodiments 1-6, wherein the pressure swing adsorption system is configured to remove carbon dioxide and impurities from the output of the output of the shift reactor.

Embodiment 8: A method for producing hydrogen, the method comprising: generating, via a reformer unit, a reformate gas by a steam-methane reaction aided by an iron sulfide catalyst; generating additional hydrogen, via a shift reactor, by a water-shift reaction applied to the reformate gas; and utilizing a presence of the iron sulfide catalyst within the reformate gas to lower the activation energy of the water-gas shift reaction.

Embodiment 9: The method according to embodiment 8, further comprising: supplying a high water cut byproduct from a hydrocarbon well to a water treatment system; and supplying a natural gas stream from the hydrocarbon well to a methane purification system.

Embodiment 10: The method according to any of embodiments 8-9, further comprising: treating, via the water treatment system, the high water cut byproduct to remove contaminants and produce a treated water stream; heating the treated water stream to generate a steam supply; and generating, via the methane purification system, a purified methane stream that comprises at least 95 molar percent methane.

Embodiment 11: The method according to any of embodiments 8-10, further comprising: mixing the steam supply and the purified methane stream to form an inlet stream; and supplying the inlet stream to one or more catalyst filled tubes of the reformer unit to undergo the steam-methane reaction.

Embodiment 12: The method according to any of embodiments 8-11, wherein reaction conditions within the reformer unit include a temperature between 600 and 1000 degrees Celsius and a pressure between 150 and 350 pounds per square inch.

Embodiment 13: The method according to any of embodiments 8-12, further comprising: purifying an output of the shift reactor to generate a hydrogen stream.

Embodiment 14: The method according to any of embodiments 8-13, wherein the purifying employs a pressure swing adsorption system to remove carbon dioxide and contaminants from the output of the shift reactor to generate the hydrogen stream.

Embodiment 15: A system, comprising: a water treatment system coupled to a steam generator, wherein the water treatment system is configured to remove contaminants from a water supply derived from a hydrocarbon well and provide treated water to the steam generator, and wherein the steam generator heats the treated water to provide steam to the reformer unit; a reformer unit configured to generate a reformate gas via a steam-methane reaction that is aided by an iron sulfide catalyst; and a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas.

Embodiment 16: The system of embodiment 15, wherein the water supply is a high water cut byproduct of the hydrocarbon well, and wherein the contaminants are derived from hydrocarbon extraction operations performed at the hydrocarbon well.

Embodiment 17: The system of any of embodiments 15-16, further comprising: a methane purification system operably coupled to the reformer unit, wherein the methane purification system is configured to generate a methane gas stream for the steam-methane reaction, and wherein the methane gas stream comprises at least 95 molar percent methane.

Embodiment 18: The system of any of embodiments 15-17, wherein the steam and the methane gas is provided to the reformer unit at a steam-to-carbon ratio of 2.5:1 to 3:1.

Embodiment 19: The system of any of embodiments 15-18, further comprising: a pressure swing adsorption system operably coupled to the shift reactor, wherein the pressure swing adsorption system is configured to generate a purified hydrogen stream from an output of the shift reactor.

Embodiment 20: The system of any of embodiments 15-19, wherein the pressure swing adsorption system is configured to remove carbon dioxide and impurities from the output of the output of the shift reactor.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A system for producing hydrogen, the system comprising:
a reformer unit configured to generate a reformate gas via a steam-methane reaction that is aided by an iron sulfide catalyst; and,
a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas.

2. The system of claim 1, further comprising:
a steam generator operably coupled to the reformer unit, wherein the steam generator is configured to generate steam for the steam-methane reaction from a water supply sourced from a hydrocarbon well.

3. The system of claim 3, further comprising:
a water treatment system operably coupled to the steam generator, wherein the water treatment system is configured to remove contaminants from the water supply prior to supplying the water supply to the steam generator.

4. The system of claim 2, further comprising:
a methane purification system operably coupled to the reformer unit, wherein the methane purification system is configured to generate a methane gas stream for the steam-methane reaction, and wherein the methane gas stream comprises at least 95 molar percent methane.

5. The system of claim 4, wherein reaction conditions within the shift reactor include a temperature between 200 and 400 degrees Celsius and a pressure between 150 and 350 pounds per square inch.

6. The system of claim 4, further comprising:
a pressure swing adsorption system operably coupled to the shift reactor, wherein the pressure swing adsorption system is configured to generate a purified hydrogen stream from an output of the shift reactor.

7. The system of claim 6, wherein the pressure swing adsorption system is configured to remove carbon dioxide and impurities from the output of the output of the shift reactor.

8. A method for producing hydrogen, the method comprising:
generating, via a reformer unit, a reformate gas by a steam-methane reaction aided by an iron sulfide catalyst;
generating additional hydrogen, via a shift reactor, by a water-shift reaction applied to the reformate gas; and,
utilizing a presence of the iron sulfide catalyst within the reformate gas to lower the activation energy of the water-gas shift reaction.

9. The method of claim 8, further comprising:
supplying a high water cut byproduct from a hydrocarbon well to a water treatment system; and
supplying a natural gas stream from the hydrocarbon well to a methane purification system.

10. The method of claim 9, further comprising:
treating, via the water treatment system, the high water cut byproduct to remove contaminants and produce a treated water stream;
heating the treated water stream to generate a steam supply; and
generating, via the methane purification system, a purified methane stream that comprises at least 95 molar percent methane.

11. The method of claim 10, further comprising:
mixing the steam supply and the purified methane stream to form an inlet stream; and
supplying the inlet stream to one or more catalyst filled tubes of the reformer unit to undergo the steam-methane reaction.

12. The method of claim 11, wherein reaction conditions within the reformer unit include a temperature between 600 and 1000 degrees Celsius and a pressure between 150 and 350 pounds per square inch.

13. The method of claim 11, further comprising:
purifying an output of the shift reactor to generate a hydrogen stream.

14. The method of claim 13, wherein the purifying employs a pressure swing adsorption system to remove carbon dioxide and contaminants from the output of the shift reactor to generate the hydrogen stream.

15. A system, comprising:
a water treatment system coupled to a steam generator, wherein the water treatment system is configured to remove contaminants from a water supply derived from a hydrocarbon well and provide treated water to the steam generator, and wherein the steam generator heats the treated water to provide steam to the reformer unit;
a reformer unit configured to generate a reformate gas via a steam-methane reaction that is aided by an iron sulfide catalyst; and,
a shift reactor operably coupled to the reformer unit, wherein the shift reactor is configured to utilize the reformate gas to perform a water-shift reaction to produce additional hydrogen, and wherein an activation energy of the water-shift reaction is lowered by a presence of the iron sulfide catalyst in the reformate gas.

16. The system of claim 15, wherein the water supply is a high water cut byproduct of the hydrocarbon well, and wherein the contaminants are derived from hydrocarbon extraction operations performed at the hydrocarbon well.

17. The system of claim 16, further comprising:
a methane purification system operably coupled to the reformer unit, wherein the methane purification system is configured to generate a methane gas stream for the steam-methane reaction, and wherein the methane gas stream comprises at least 95 molar percent methane.

18. The system of claim 17, wherein the steam and the methane gas is provided to the reformer unit at a steam-to-carbon ratio of 2.5:1 to 3:1.

19. The system of claim 17, further comprising:
a pressure swing adsorption system operably coupled to the shift reactor, wherein the pressure swing adsorption system is configured to generate a purified hydrogen stream from an output of the shift reactor.

20. The system of claim 19, wherein the pressure swing adsorption system is configured to remove carbon dioxide and impurities from the output of the output of the shift reactor.
